(19) United States
(12) Patent Application Publication
(10) Pub. No.: US 2026/0213568 A1
(43) Pub. Date: Jul. 23, 2026

(54) TECHNOLOGIES FOR MICROGRID INTERCONNECT DEVICE WITH AUTOMATIC BACKUP POWER SWITCHING

(71) Applicant: Fronius International GmbH, Thalheim bei Wels (AT)

(72) Inventors: John Terry Toma, Jr., Crown Point, IN (US); Martin Wolf, Thalheim bei Wels (AT); Zachary Kirin, Demotte, IN (US); Hans-Peter Pimminger, Thalheim bei Wels (AT); Suresh Baddam Reddy, Peoria, IL (US)

(21) Appl. No.: 19/028,198

(22) Filed: Jan. 17, 2025

(51) Int. Cl. H02J 9/06; H02H 3/08

(52) U.S. Cl. CPC H02J 9/068; H02H 3/083

(57) ABSTRACT

Technologies for microgrid interconnect include an inverter and a backup device coupled to the inverter, the backup device including a smart meter, an autotransformer coupled to the inverter, a contactor coupled to a power grid supply and to the autotransformer, and a low-voltage ride through (LVRT) power supply coupled to the power grid supply and to the a contactor coil. When power is supplied from the power grid supply, the contactor connects the power grid supply to a backup load panel. When power is not supplied from the power grid supply, and after an LVRT duration, the contactor automatically and simultaneously disconnects the main panel and connects the autotransformer and inverter to the backup load panel. If a circuit breaker connected to the autotransformer breaks, the inverter stops outputting power. The backup device may include a manual bypass switch. Other embodiments are described and claimed.

### BACKGROUND

Microgrid systems can include local power generation systems such as photovoltaic (solar) power systems and/or battery backup systems, which may be connected to a utility interactive inverter. Typical systems may provide a means for switching the utility interactive inverter from a grid mode to a bypass mode, in which the power grid is not available.

### SUMMARY

According to one aspect of the disclosure, a system includes a main system panel comprising a power grid supply input; an inverter comprising an AC power output; a backup load panel comprising an AC power input; and a backup box device. The backup box device comprises a housing including a switch assembly, an autotransformer, and a low-voltage ride-through (LVRT) power supply. The switch assembly includes a coil assembly, a first supply input electrically coupled to power grid supply input of the main system panel, a second supply input coupled to the AC power output of the inverter, and a load output electrically coupled to the AC power input of the backup load panel. The autotransformer is electrically coupled to the second supply input of the switch assembly and to the AC power output of the inverter. The LVRT power supply includes an input electrically coupled to the power grid supply input of the main system panel and an output electrically coupled to the coil assembly of the switch assembly. The switch assembly of the backup box device is configured to selectively connect the first supply input to the load output when the LVRT power supply provides power to the coil assembly, and to connect the second supply input to the load output when the LVRT power supply does not provide power to the coil assembly.

In some embodiments, the inverter comprises a single-phase inverter having a first output voltage; and the autotransformer comprises a split-phase autotransformer that generates a first phase and a second phase, wherein each of the first phase and the second phase has a second output voltage, wherein the second output voltage is less than the first output voltage. In some embodiments, the first output voltage comprises 240 VAC and the second output voltage comprises 120 VAC.

In some embodiments, the backup box further includes a manual bypass switch configured to selectively connect the autotransformer to the AC power input of the backup panel.

In some embodiments, the switch assembly includes a first two-pole contactor and a second two-pole contactor. The first two-pole contactor is configured to selectively connect the main system panel and the load output, and the first two-pole contactor is normally open. The second two-pole contactor is configured to selectively connect the autotransformer to the load terminal, and the second two-pole contactor is normally closed. In some embodiments, the coil assembly includes a first contactor coil of the first two-pole contactor and a second contactor coil of the second two-pole contactor. The LVRT power supply includes a power converter. The input of the LVRT power supply includes an AC input. The output of the LVRT power supply includes a DC output. The DC output is coupled in parallel to the first contactor coil, the second contactor coil, and an LVRT capacitor. In some embodiments, the LVRT capacitor has a capacitance that is configured to retain voltage to activate the first contactor coil and the second contactor coil for at least a predetermined time period after the power converter loses power from the main system panel, wherein the predetermined time period comprises ten seconds.

In some embodiments, the backup box includes a feedback line coupled from a positive output terminal of the inverter to a digital input of the inverter. The feedback line includes a first remote relay and a second remote relay connected in series. Each of the first remote relay and a second remote relay are normally closed, the first remote relay is activated by the first contactor coil, and the second remote relay is activated by the second contactor coil. In some embodiments, the inverter is configured to operate in a grid mode in response to an open circuit on the digital input and to operate in a backup mode in response to a positive signal on the digital input. In some embodiments, the system further includes a control relay electrically coupled between the power grid supply input of the main system panel and the LVRT power supply. The control relay is normally closed. The control relay includes a coil coupled to a digital output of the inverter, and the control relay opens in response to a signal asserted on the digital output. In some embodiments, the system further includes a second feedback line electrically coupled between the feedback line and a second digital input of the inverter. The second feedback line includes a third remote relay. The third remote relay is normally open, and the third remote relay closes in response to the signal asserted on the digital output.

In some embodiments, the autotransformer includes an overcurrent protective device (OCPD); and the inverter stops power output in response to a detection that the OCPD of the autotransformer has tripped. In some embodiments, the backup box device further includes a smart meter. The smart meter is coupled to the power grid supply input of the main system panel, and the smart meter is communicatively coupled to the inverter.

In some embodiments, the system further includes a manual bypass switch configured to selectively connect the autotransformer or the power grid supply line to the AC power input of the backup panel. The switch assembly includes a four-pole contactor that comprises a first pair of poles and a second pair of poles. The first pair of poles are electrically coupled to the main system panel, and the second pair of poles are electrically coupled to the autotransformer. The coil assembly includes a contactor coil electrically coupled to the output of the LVRT power supply. When the contactor coil is energized, the first pair of poles are electrically connected to the load output, and when the contactor coil is not energized, the second pair of poles are electrically connected to the load output.

In some embodiments, the system further includes a low-power switch. The switch assembly includes a four-pole contactor that comprises a first pair of poles and a second pair of poles. The first pair of poles are electrically coupled to the main system panel, and the second pair of poles are electrically coupled to the autotransformer. The coil assembly includes an AC/DC coil coupled to an output of the low-power switch. The LVRT power supply includes a power converter having an AC input coupled to the power grid supply input and a DC output coupled to a first input of the low-power switch. A second input of the low-power switch is coupled to the power grid supply input of the main panel. The low-power switch is configured to selectively connect the power grid supply input or the DC output to the AC/DC coil. In some embodiments, the system further includes a relay electrically coupled between the power grid supply input and the low-power switch. A first input terminal of the relay is coupled to a first leg of the power grid supply input; a second input terminal of the relay is coupled to a second leg of the power grid supply input; and a coil of the relay is electrically coupled to the second leg of the power grid supply input. When the coil is energized, the relay electrically connects the second leg to the low-power switch, and when the coil is not energized, the relay electrically connects the first leg to the low-power switch.

In some embodiments, the switch assembly includes a contactor that is normally in a first state in which the power supply grid input is connected to the load output and the autotransformer is not connected to the load output. The switch assembly further includes a mechanical latching accessory that holds the contactor in the first state when the power grid supply input loses power. The inverter is configured to wait for a predetermined time in response to a determination that the power grid supply input loses power and to cause the mechanical latching accessory to change state of the contactor in response to waiting for the predetermined time. In some embodiments, the switch assembly further includes an RC circuit configured to store sufficient energy to change the state of the contactor.

According to another aspect, a device includes a contactor including a contactor coil, a first supply input, a second supply input, and a load output; an autotransformer electrically coupled to the second supply input of the contactor and to an AC inverter power input; and a low-voltage ride-through (LVRT) power supply including an input electrically coupled to the first supply input and an output electrically coupled to the contactor coil. The switch assembly is configured to selectively connect the first supply input to the load output when the LVRT power supply provides power to the contactor coil, and to connect the second supply input to the load output when the LVRT power supply does not provide power to the contactor coil.

In some embodiments, the AC inverter power input includes a single-phase input having a first input voltage. The autotransformer comprises a split-phase autotransformer that generates a first phase and a second phase. Each of the first phase and the second phase has a second output voltage. The second output voltage is less than the first input voltage.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified block diagram of at least one embodiment of a system for a microgrid interconnect device with automated backup power switching;

FIG. 2 is a simplified electrical schematic diagram of at least one embodiment of the system of FIG. 1;

FIG. 3 is a simplified electrical schematic diagram of at least one additional embodiment of the system of FIG. 1 including a manual bypass switch;

FIG. 4 is a simplified electrical schematic diagram of at least one further additional embodiment of the system of FIG. 1 including a bypass switch;

FIG. 5 is a simplified electrical schematic diagram of at least one further additional embodiment of the system of FIG. 1; and

FIG. 6 is a simplified electrical schematic diagram of at least one further additional embodiment of the system of FIG. 1 including a mechanical latching accessory.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

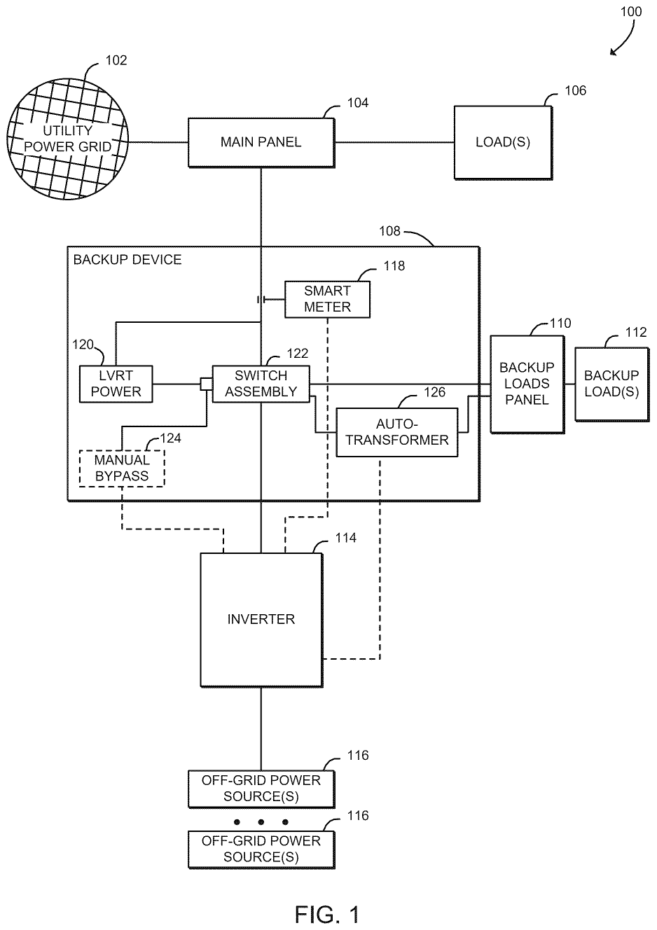

Referring now to FIG. 1, an illustrative system 100 for a microgrid interconnect device with automated backup power switching includes a main system panel 104 coupled to a utility power grid 102 and an inverter 114 coupled to one or more off-grid power sources 116. A backup device 108 is coupled to both the main panel 104 and the inverter 114, and is further coupled to a backup panel 110. As described further below, when power is available from the utility power grid 102, in use the backup device 108 may operate in a grid mode, and power may be supplied from the power grid 102 to one or more loads 106 coupled to the main panel 104 as well as to one or more backup loads 112 coupled to the backup panel. When power is not available from the power grid 102, the backup device 108 automatically switches to supplying power from the inverter 114 to the backup loads 112. The backup device 108 has an energy buffer sufficient to perform switching after waiting out a corresponding low-voltage ride-through (LVRT) time. In contrast to typical systems, the system 100 provides a relatively high buffer energy for supporting LVRT and in some cases the LVRT is adjustable through programming or other means. Additionally, as described further below, the system 100 may provide split-phase backup power from a single phase inverter 114 while providing protection to loads in the event of transformer failures, such as excessive load imbalance between the split phases.

Referring again to FIG. 1, the utility power grid 102 may be embodied as a wide area power grid or any other power delivery network or interconnected group of power delivery networks. As such, the power grid 102 may include multiple power plants, loads, transmission lines, busses, and other electrical production, distribution, and consumption equipment. The power grid 102 is illustratively connected to the main panel 104. Grid power from the main panel 104 may be connected to the loads 106, which may be protected by one or more protective devices such as residual current devices, circuit breakers, or fuses (not shown in FIG. 1).

The inverter 114 may be embodied as a single-phase grid-interactive inverter such as a Fronius Primo Gen24 family inverter, commercially available from Fronius USA LLC. The inverter 114 may receive power from one or more off-grid power sources 116 and, using that input power, generate AC power on an AC power output, for example as 240 VAC power. The power sources 116 may be embodied as, for example, any combination of solar panels, strings of solar panels, batteries connected in series and/or parallel, or other power sources 116. Accordingly, such off-grid power sources 116 may be DC power sources.

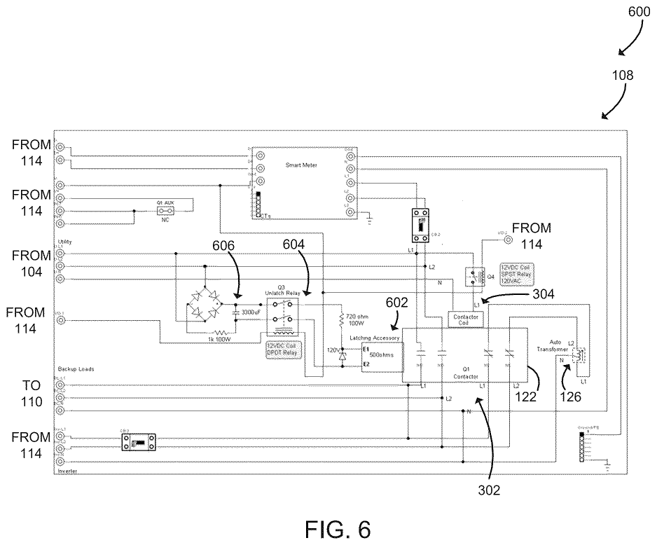

The backup device 108 may be embodied as a backup box or other enclosure, which may be installed at the same location as or otherwise near the main panel 104. In some embodiments, the enclosure may include a membrane or other vent that allows airflow is not permeable by water or other contaminants, which may reduce condensation within the enclosure. As shown, the backup device 108 includes a smart meter 118, a low-voltage ride-through (LVRT) power supply 120, a switch assembly 122, and an autotransformer 126. In some embodiments, the backup device 108 may include a manual bypass switch 124 or may exclude LVRT power 120 and instead include a latching accessory 602 and supporting circuitry 606, as described further below in connection with FIG. 6.

The autotransformer 126 is coupled to the switch assembly 122. When the switch assembly 122 connects the autotransformer 126 it is configured to transform AC power received from the inverter 114 into two split phases each having a lower voltage than the power produced by the inverter 114. For example, the autotransformer 126 may receive 240 VAC power from the inverter 114 and generate two split phases of 120 VAC power. The autotransformer 126 may be cooled using one or more thermal pads or other thermal interface material (TIM) coupled between the autotransformer 126 and a heat sink, for example a heat sink formed from aluminum. Accordingly, heat produced by the autotransformer 126 may be transferred to the surrounding environment.

The switch assembly 122 is coupled to grid power from the main panel 104 and to the inverter 114. Output from the switch assembly 122 is coupled to the backup panel 110, thereby allowing output from the switch assembly 122 to power the backup loads 112. The backup loads 112 may be embodied as critical loads or other loads that should remain operable during a power outage of the power grid 102, such as freezers, fans, or other loads. The switch assembly 122 is operable to keep the grid power from the main panel 104, the inverter 114 and the backup panel 110 all connected together or to disconnect the main panel 104 from the inverter 114 and backup panel 110 while simultaneously connecting the autotransformer 126. As described further below, the switch assembly 122 may be embodied as one or more contactors, relays, or other electrically operated switches.

As shown, the LVRT power supply 120 is connected to grid power from the main panel 104 and to the switch assembly 122. When grid power is available, the LVRT power supply 120 causes the switch assembly 122 to connect the grid power from the main panel 104 to the backup panel 110. When grid power is not available from the main panel 104, the LVRT power supply 120 maintains an energy buffer that allows the switch assembly 122 to keep connecting the grid power from the main panel 104 to the backup panel 110 for a LVRT duration, such as ten seconds. When grid power is not available after the LVRT duration, the switch assembly 122 connects the backup power from the autotransformer 126 (supplied by the inverter 114) to the backup panel 110.

As discussed above, in some embodiments, the backup device 108 further includes a manual bypass switch 124. The manual bypass switch 124 may be configured to allow manual connection of the autotransformer 126 to the backup panel 110 without regard to the state of the LVRT power 120 or other components of the backup device 108. Accordingly, the manual bypass switch 124 may allow power to the backup panel 110 when grid power is available, if one or more components malfunction, or in other circumstances.

The smart meter 118 is coupled to the grid power supplied by the main panel 104, and may be communicatively coupled to the inverter 114. The smart meter 118 may be embodied as, for example, a Fronius Smart Meter available from Fronius USA LLC. Additionally, the inverter 114 may be communicatively coupled to the switch assembly 122, the manual bypass 124, the autotransformer 126, and/or one or more other sensors, switches, position sensors, or other components of the system 100.

In use, the inverter 114 and the backup device 108 (e.g., the smart meter 118 and/or other controller or control element of the backup device 108) may perform a handshake protocol. In particular, the inverter 114 may determine whether a protective device (e.g., a circuit breaker or fuse) coupled to the autotransformer 126 trips, for example due to excessive load imbalance in the autotransformer 126. When the protective device for the autotransformer 126 trips, the autotransformer 126 may be disconnected from backup power being provided by the inverter 114 in backup mode. This may cause the backup loads 112 coupled to the backup panel 110 to no longer have support for unbalanced loads. Accordingly, if such an autotransformer protective device trips, then the inverter 114 does not stay in backup mode, and stops outputting AC power. This response from the inverter 114 occurs fast enough that the backup loads 112 will not be damaged, for example occurring within seconds. Additional feedback such as grid connection (via the smart meter 118), on/off positions of components (e.g., contactors, switches, relays, etc.) may be provided to the inverter 114 so that the programming of the inverter 114 (e.g., state machine logic) can operate grid and backup modes safely. Illustratively, the state machine programming in the inverter 114 may use inputs from the smart meter 118, contactor 122 position, bypass switch 124 position (both arranged in a way to provide specific feedback), and other relay position (which may be activated by the inverter 114 using an I/O port) to determine the safe and proper mode of operation.

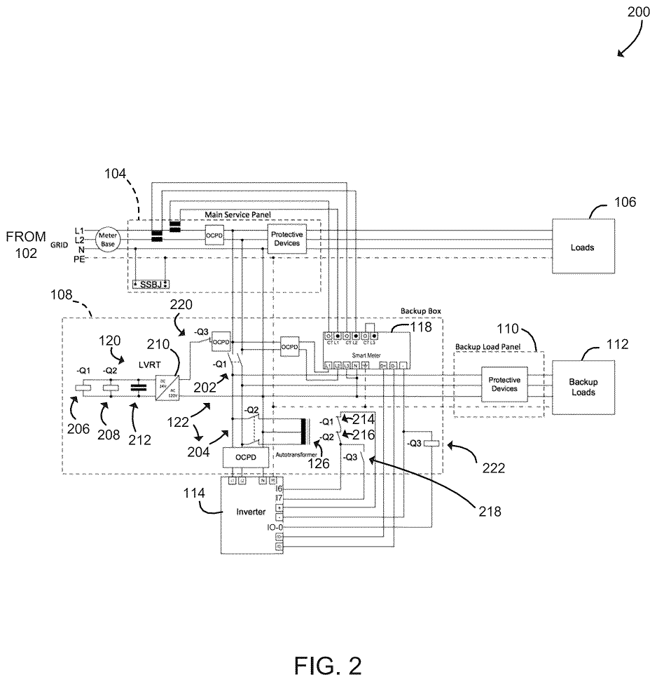

Referring now to FIG. 2, schematic diagram 200 illustrates one potential embodiment of the system 100. As shown, the main panel 104 receives grid power from the power grid 102, which is illustratively embodied as a two-phase residential power supply at 240 VAC including two phase lines L1 and L2 and a neural line N. As shown, the loads 106 are connected to the grid power (e.g., to L1, L2, and N) via one or more protective devices such as residual current devices, circuit breakers, or fuses. The smart meter 118 is coupled to lines L1, L2 of the main service panel 104 via current transducers.

As shown, the switch assembly 122 includes a pair of contactors 202, 204, which are labeled Q1, Q2, respectively. The contactors 202, 204 further include corresponding contactor coils 206, 208. The LVRT power supply 120 includes an AC/DC power converter 210, which receives AC power via L1 from the main service panel 104, and outputs DC power to the contactor coils 206, 208 in parallel. An LVRT capacitor 212 is also coupled in parallel to the DC output of the power converter 210. When power is not available from the power converter 210, the LVRT capacitor 212 provides power to the contactor coils 206, 208, allowing them to remain closed for the duration of the LVRT time. The capacitance of the capacitor 212 is selected to provide the required LVRT time, which is illustratively 10 seconds.

As shown, the contactor 202 is normally open and is coupled between the main service panel 114 (e.g., lines L1, L2) and the backup load panel 110 (e.g., corresponding lines L1, L2). The contactor 202 is configured to connect L1, L2 from the main service panel 104 to L1, L2 of the backup load panel 110 when the contactor coil 206 is energized.

The contactor 204 is normally closed, and is coupled between the autotransformer 126 (e.g., two taps of the autotransformer 126) and the backup load panel 110 (e.g. lines L1, L2). Those two taps of the autotransformer 126 are also connected to AC power output from the inverter 114 (e.g., lines L1, L2 from the inverter 114). The center tap of the autotransformer 126 is coupled to the neutral line N of the system 100. The contactor 204 is configured to connect lines L1, L2 from the autotransformer 126 (and the inverter 114) to L1, L2 of the backup load panel 110 when the contactor coil 208 is not energized.

As shown, the inverter 114 further includes a digital input I6, which is coupled to a feedback line that includes switches 214, 216 connected in series with a positive output of the inverter 114. The switches 214, 216 may be embodied as normally closed relays that are activated by the respective contactor coils 206, 208. Thus, when the contactor coils 206, 208 are energized, the switches 214, 216 are opened, and the digital input I6 may sense an open circuit or other non-positive value. When the contactor coils 206, 208 are not energized, for example after expiration of the LVRT duration, the switches 214, 216 are closed, and the digital input I6 senses a positive value. In response to sensing this positive value, the inverter 114 may enter backup mode and generate AC power accordingly.

The inverter 114 further includes an I/O port 0 and a digital input port I7. The digital input port I7 is coupled to a feedback line that includes a normally open switch 218. The feedback line of the switch 218 is coupled to the feedback line of the switches 214, 216 such that all three switches 214, 216, 218 are coupled in series between the digital input I7 and the positive output of the inverter 114. A normally closed switch 220 is coupled between the main service panel 204 (i.e., the line L1) and the power converter 210. A relay coil 222, labeled Q3, is coupled to the I/O port 0 of the inverter 114. When no value is asserted on the I/O port 0, the relay coil 222 is not energized, and the switch 220 remains closed and the switch 218 remains open. The digital input I7 may sense an open circuit or other non-positive value. When a positive value is asserted on the I/O port 0, the relay coil 222 is energized, the switch 220 opens, and the switch 218 closes. Opening the switch 220 disconnects power from the power converter 210, which will eventually cause the contactors 202, 204 to switch to backup mode in which the autotransformer 126 is connected to the backup load panel 110. Closing the switch 218 will cause the digital input I7 to sense a positive value after the switches 214, 216 are also closed. Accordingly, the relay Q3 activated by I/O port 0 may disable activation of the contactor 204 and prevent a grid connection while operating in backup mode. Illustratively, the inverter 114 may provide a 12 VDC source for the feedback lines through the positive and negative connections, and may also provide 12 VDC when the I/O port 0 is activated.

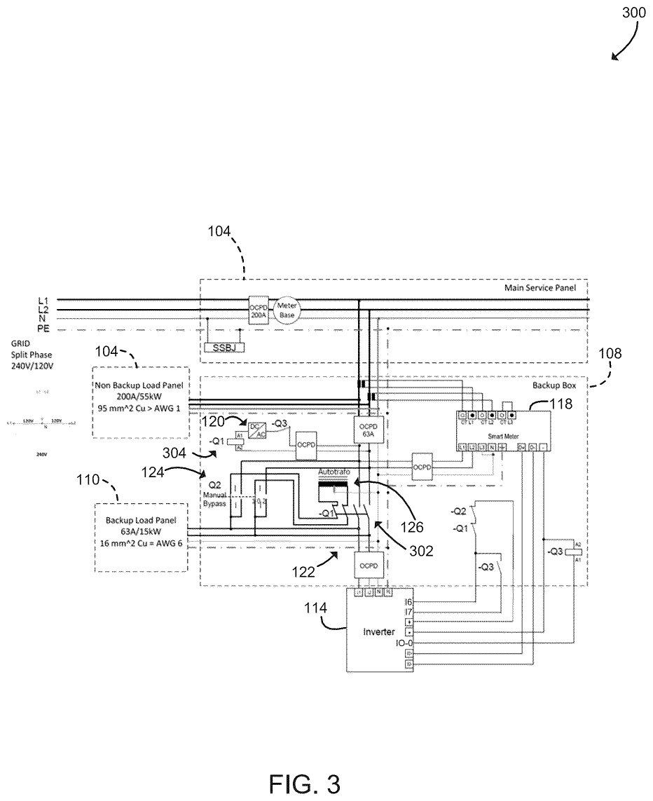

Referring now to FIG. 3, a schematic diagram illustrates a system 300, which is another potential embodiment of the system 100. The illustrative system 300 includes many of the same components illustrated in FIGS. 1-2 and described above, the description of which is not repeated herein so as not to obscure the disclosure. In addition to those components, the system 300 includes a manual bypass switch coupled between the backup load panel 110 (e.g. lines L1, L2) and the main service panel 104 (e.g., lines L1, L2) or the autotransformer 126. Accordingly, the manual bypass switch 124 may bypass components that are in between the power grid and the backup load panel 10 (e.g., the LVRT power supply 120 as shown). The manual bypass switch 124 may be required to switch high current (e.g., 60 A or more) as it switches the whole load applied to the backup load panel 110. Additionally or alternatively, it should be understood that in other embodiments of the system 300, the neutral line N entering the main panel 104 from the grid 102 may not pass through the overcurrent protection device (OCPD).

In addition to the manual bypass switch 124, the system 300 includes a single four-pole contactor 302 used as the switch assembly 122. As shown, the contactor 302 includes a pair of poles that are normally closed and that are coupled to the autotransformer 126, and another pair of poles that are normally open and that are coupled to the main service panel 104 (e.g., lines L1, L2). The contactor 302 includes a contactor coil 304 that is coupled to the DC output of the LVRT power supply 120. In operation, the system 300 operates as described above in connection with FIG. 2.

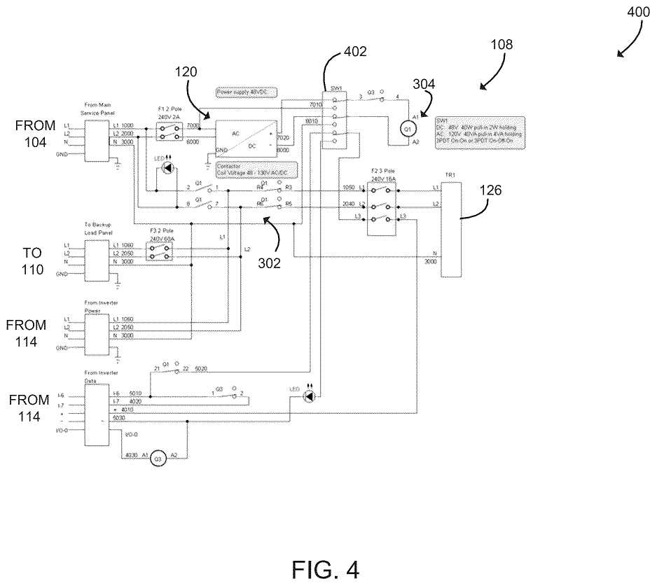

Referring now to FIG. 4, a schematic diagram illustrates a system 400, which is another potential embodiment of the system 100. The illustrative system 400 includes many of the same components illustrated in FIGS. 1-3 and described above, the description of which is not repeated herein so as not to obscure the disclosure. As shown, the system 400 illustrates a four-pole contactor 302 with a contactor coil 304, similar to the system 300 shown in FIG. 3. In the illustrative embodiment shown in FIG. 4, the contactor coil 304 is an AC/DC coil, capable of being activated by either AC power or DC power.

Additionally the system 400 includes a switch 402 coupled between the LVRT power supply 120 and the contactor coil 304. The switch 402 may be embodied as a relatively low-power three-pole double-throw (3PDT) switch. As shown, the switch 402 may be configured to connect either the DC output of the LVRT power supply 120 or the grid power from the main service panel 104 (illustratively L1 only) to the contactor coil 304.

Accordingly, the system 400 shown in FIG. 4 uses a contactor 302 with an AC/DC coil 304 using the DC input mode when in normal operation mode, and the AC input mode for when the DC source fails. The system 400 may provide a low power switch 402 that allows switching the contactor 302 operation from DC mode to AC mode. This may provide a safety mechanism for preventing damaging surges by only using the contactor 302 for switching.

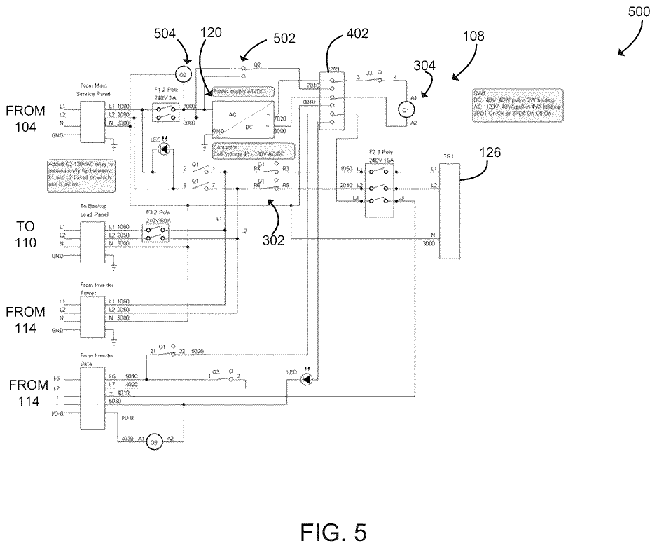

Although the system 400 shown in FIG. 4 may use AC power from line L1 if the DC source fails, it is not able to use power from line L2 if line L1 fails. Referring now to FIG. 5, schematic diagram illustrates a system 500, which is another potential embodiment of the system 100. The illustrative system 500 includes many of the same components illustrated in FIGS. 1-4 and described above, the description of which is not repeated herein so as not to obscure the disclosure. As shown, the system 500 includes an additional relay 502 coupled between the switch 402 and the main service panel 104 (e.g., the lines L1, L2). As shown, the relay 502 can switch between supplying either of the lines L1, L2 to the switch 402. A coil 504 for the relay 502 is coupled to the line L1. Accordingly, when line L1 fails, the relay 502 may switch to line L2. Thus, when line L1 fails but line L2 remains active, the system 500 uses the relay 502 to keep the contactor 302 active.

Referring now to FIG. 6, schematic diagram illustrates a system 600, which is another potential embodiment of the system 100. The illustrative system 600 includes many of the same components illustrated in FIGS. 1-5 and described above, the description of which is not repeated herein so as not to obscure the disclosure. As shown, rather than including an LVRT power supply 120, the illustrative system 600 includes a mechanical latching accessory 602 coupled to the contactor 302. The latching accessory 602 mechanically holds the contactor 302 closed (e.g., in its current state) even after power has been removed from the contactor coil 304. Additionally or alternatively, the contactor 302 may be embodied as a bi-stable contactor, which remains in its current state without application of power to the contactor coil 304.

The contactor 302 may be released by programming from the inverter 114, another programmed component (e.g., a programmable logic controller (PLC), a microcontroller, or other controller), and/or timer relays after the LVRT duration has been satisfied. For example, an unlatch relay 604 may be activated by the inverter 114, which causes the latching accessory 602 to allow the contactor 302 to open (i.e., change state). Having the inverter 114 unlatch the contactor 302 may allow programmable ride through parameters, including frequency parameters, and may accommodate changes to standards (e.g., UL1741) or other ride through requirements.

As shown, a resistor-capacitor (RC) circuit 606 may store energy, which is sufficient to change the state of the contactor 302. Additionally or alternatively, in some embodiments the system 600 may include a battery used to store energy, which may be used to change the state of the contactor 302. This battery may also be charged with the rectifier bridge shown in FIG. 6. Additionally or alternatively, the latching accessory 602 may have a manual release and/or a bi-stable contactor may have a manual switch. This mechanical latching solution of FIG. 6 may eliminate the power supply, which may be an in-between component that is susceptible to failure modes. Additionally, the latching solution of FIG. 6 requires no power itself to keep the contactor 302 in its active state.

What is claimed is:

1. A system comprising:
a main system panel comprising a power grid supply input;
an inverter comprising an AC power output;
a backup load panel comprising an AC power input; and
a backup box device, the backup box device comprising a housing including:
a switch assembly comprising a coil assembly, a first supply input electrically coupled to power grid supply input of the main system panel, a second supply input coupled to the AC power output of the inverter, and a load output electrically coupled to the AC power input of the backup load panel;
an autotransformer electrically coupled to the second supply input of the switch assembly and to the AC power output of the inverter; and
a low-voltage ride-through (LVRT) power supply comprising an input electrically coupled to the power grid supply input of the main system panel and an output electrically coupled to the coil assembly of the switch assembly;
wherein the switch assembly of the backup box device is configured to selectively connect the first supply input to the load output when the LVRT power supply provides power to the coil assembly, and to connect the second supply input to the load output when the LVRT power supply does not provide power to the coil assembly.

2. The system of claim 1, wherein:
the inverter comprises a single-phase inverter having a first output voltage; and
the autotransformer comprises a split-phase autotransformer that generates a first phase and a second phase, wherein each of the first phase and the second phase has a second output voltage, wherein the second output voltage is less than the first output voltage.

3. The system of claim 2, wherein the first output voltage comprises 240 VAC and the second output voltage comprises 120 VAC.

4. The system of claim 1, wherein the backup box further comprises a manual bypass switch configured to selectively connect the autotransformer to the AC power input of the backup panel.

5. The system of claim 1, wherein:
the switch assembly comprises a first two-pole contactor configured to selectively connect the main system panel and the load output, wherein the first two-pole contactor is normally open; and a second two-pole contactor configured to selectively connect the autotransformer to the load terminal, wherein the second two-pole contactor is normally closed.

6. The system of claim 5, wherein:
the coil assembly comprises a first contactor coil of the first two-pole contactor and a second contactor coil of the second two-pole contactor; and
the LVRT power supply comprises a power converter, wherein the input of the LVRT power supply comprises an AC input the output of the LVRT power supply comprises a DC output, wherein the DC output is coupled in parallel to the first contactor coil, the second contactor coil, and an LVRT capacitor.

7. The system of claim 6, wherein the LVRT capacitor has a capacitance that is configured to retain voltage to activate the first contactor coil and the second contactor coil for at least a predetermined time period after the power converter loses power from the main system panel, wherein the predetermined time period comprises ten seconds.

8. The system of claim 5, wherein the backup box comprises a feedback line coupled from a positive output terminal of the inverter to a digital input of the inverter, wherein the feedback line comprises a first remote relay and a second remote relay connected in series, wherein each of the first remote relay and a second remote relay are normally closed, and wherein the first remote relay is activated by the first contactor coil, and wherein the second remote relay is activated by the second contactor coil.

9. The system of claim 8, wherein the inverter is configured to (i) operate in a grid mode in response to an open circuit on the digital input and (ii) operate in a backup mode in response to a positive signal on the digital input.

10. The system of claim 8, further comprising a control relay electrically coupled between the power grid supply input of the main system panel and the LVRT power supply, wherein the control relay is normally closed;
wherein the control relay comprises a coil coupled to a digital output of the inverter; and
wherein the control relay opens in response to a signal asserted on the digital output.

11. The system of claim 10, further comprising a second feedback line electrically coupled between the feedback line and a second digital input of the inverter, wherein the second feedback line comprises a third remote relay, wherein the third remote relay is normally open, and wherein the third remote relay closes in response to the signal asserted on the digital output.

12. The system of claim 1, wherein:
the autotransformer comprises an overcurrent protective device (OCPD); and
the inverter stops power output in response to a detection that the OCPD of the autotransformer has tripped.

13. The system of claim 1, wherein the backup box device further comprises a smart meter, wherein the smart meter is coupled to the power grid supply input of the main system panel, and wherein the smart meter is communicatively coupled to the inverter.

14. The system of claim 1, further comprising:
a manual bypass switch configured to selectively connect the autotransformer or the power grid supply line to the AC power input of the backup panel;
wherein the switch assembly comprises a four-pole contactor comprising a first pair of poles and a second pair of poles, wherein the first pair of poles are electrically coupled to the main system panel, and the second pair of poles are electrically coupled to the autotransformer;
wherein the coil assembly comprises a contactor coil electrically coupled to the output of the LVRT power supply;
wherein when the contactor coil is energized the first pair of poles are electrically connected to the load output, and when the contactor coil is not energized the second pair of poles are electrically connected to the load output.

15. The system of claim 1, further comprising a low-power switch; wherein:
the switch assembly comprises a four-pole contactor comprising a first pair of poles and a second pair of poles, wherein the first pair of poles are electrically coupled to the main system panel, and the second pair of poles are electrically coupled to the autotransformer;
the coil assembly comprises an AC/DC coil coupled to an output of the low-power switch;
the LVRT power supply comprises a power converter having an AC input coupled to the power grid supply input and a DC output coupled to a first input of the low-power switch; and
a second input of the low-power switch is coupled to the power grid supply input of the main panel, wherein the low-power switch is configured to selectively connect the power grid supply input or the DC output to the AC/DC coil.

16. The system of claim 15, further comprising a relay electrically coupled between the power grid supply input and the low-power switch, wherein:
a first input terminal of the relay is coupled to a first leg of the power grid supply input;
a second input terminal of the relay is coupled to a second leg of the power grid supply input;
a coil of the relay is electrically coupled to the second leg of the power grid supply input; and
when the coil is energized, the relay electrically connects the second leg to the low-power switch, and wherein when the coil is not energized, the relay electrically connects the first leg to the low-power switch.

17. The system of claim 1, wherein:
the switch assembly comprises a contactor that is normally in a first state in which the power supply grid input is connected to the load output and the autotransformer is not connected to the load output;
the switch assembly further comprises a mechanical latching accessory that holds the contactor in the first state when the power grid supply input loses power;
the inverter is configured to wait for a predetermined time in response to a determination that the power grid supply input loses power and cause the mechanical latching accessory to change state of the contactor in response to waiting for the predetermined time.

18. The system of claim 17, wherein the switch assembly further comprises an RC circuit configured to store sufficient energy to change the state of the contactor.

19. A device comprising:
a contactor comprising a contactor coil, a first supply input, a second supply input, and a load output;
an autotransformer electrically coupled to the second supply input of the contactor and to an AC inverter power input; and
a low-voltage ride-through (LVRT) power supply comprising an input electrically coupled to the first supply input and an output electrically coupled to the contactor coil;
wherein the switch assembly is configured to selectively connect the first supply input to the load output when the LVRT power supply provides power to the contactor coil, and to connect the second supply input to the load output when the LVRT power supply does not provide power to the contactor coil.

20. The device of claim 19, wherein:
the AC inverter power input comprises a single-phase input having a first input voltage; and
the autotransformer comprises a split-phase autotransformer that generates a first phase and a second phase, wherein each of the first phase and the second phase has a second output voltage, wherein the second output voltage is less than the first input voltage.
